(19) United States
(12) Patent Application Publication
(10) Pub. No.: US 2013/0085842 A1
(43) Pub. Date: Apr. 4, 2013

(54) DATA CENTER-LESS DISTRIBUTED SOCIAL NETWORK FOR ONLINE MARKETPLACES

(71) Applicants: RAMSES MORALES, Sunnyvale, CA (US); YU AN SUN, Webster, NY (US)

(72) Inventors: RAMSES MORALES, Sunnyvale, CA (US); YU AN SUN, Webster, NY (US)

(73) Assignee: Xerox Corporation, Norwalk, CT (US)

(21) Appl. No.: 13/248,332

(22) Filed: Sep. 29, 2011

(51) Int. Cl. G06Q 30/02; G06Q 30/08

(52) U.S. Cl. 705/14.49

(57) ABSTRACT

In accordance with one aspect illustrated herein, a system is provided comprising a plurality of devices implementing a plurality of peer nodes coupled to a data-center-less network, wherein each of the plurality of devices implements at least one peer node. At least one of the plurality of peer nodes is configured as a publisher peer node for a plurality of contents cached on the respective peer node. Each publisher peer node is configured to publish one or more advertisements on the network. The data-center-less network can be built automatically from user interactions in the markets and includes proactive replication of advertisements to relevant micro-markets. The system still further provides automatic suggesting of the advertisements to a bidder, which are located in a different market, but are relevant to the bid. The automatic suggesting is based upon a computed strength of a connection between the publisher and the bidder using prior interactions.

### BACKGROUND

Currently, labor marketplaces, or other topical markets, (hereinafter “micro-markets”) typically are operating as isolated sites that do not communicate amongst one another. For example, jobs and bids posted to one site are only viewable by users who belong to that particular site. One problem identified to enable communication among different sites, is how to create a social networking system in the absence of dedicated infrastructure, and without modification of the micro-market software. One solution includes a system that can be distributed, in a peer-to-peer (P2P) manner, taking advantage of the hosts where micro-markets are running.

An additional problem is the use of the system to enable new micro-market features, such as advertising of job postings using the social network dynamically created by the users. Instead of using keyword or category tags as job advertising mechanisms, the present disclosure proposes using connections among users based on past working relationships as advertising mechanisms.

### BRIEF DESCRIPTION

In accordance with one aspect illustrated herein, a system is provided comprising a plurality of devices implementing a plurality of peer nodes coupled to a data-center-less network, wherein each of the plurality of devices implements at least one peer node. At least one of the plurality of peer nodes is configured as a publisher peer node for a plurality of contents cached on the respective peer node. Each publisher peer node is configured to publish one or more advertisements on the network. The data-center-less network can be built automatically from user interactions in the markets and includes proactive replication of advertisements to relevant micro-markets. The system still further provides automatic suggesting of the advertisements to a bidder, which are located in a different market, but are relevant to the bid. The automatic suggesting is based upon a computed strength of a connection between the publisher and the bidder using prior interactions.

In accordance with another aspect illustrated herein, a system is provided comprising a plurality of devices implementing a plurality of peer nodes coupled to a data-center-less network. At least one of the plurality of peer nodes is configured as a publisher peer node for a plurality of contents cached on the respective peer node. Each publisher peer node is configured to publish one or more advertisements on the network. The data-center-less network is built automatically from user interactions in the markets and includes proactive replication of advertisements to relevant micro-markets. The system further provides automatic suggesting of the advertisements to a bidder, which are located in a different market, but are relevant to the bid. The automatic suggesting is based upon a computed strength of a connection between the publisher and the bidder. The computed strength of the connection is modified depending on the number of working interactions recently done together between the publisher and the bidder.

In accordance with yet another aspect illustrated herein, a system is provided comprising a plurality of devices implementing a plurality of peer nodes coupled to a data-center-less network. Each of the plurality of devices implements at least one peer node. At least one of the plurality of peer nodes is configured as a publisher peer node for a plurality of contents cached on the respective peer node, and wherein each publisher peer node is configured to publish one or more advertisements on the network. The data-center-less network is built automatically from user interactions in the markets and includes proactive replication of advertisements to relevant micro-markets. The system further provides for a computed strength of a connection between a publisher and a bidder using prior interactions wherein the connection is based upon the following:

f(window)=β·g(window)+(1−β)·h(window), where β=[0,1];

function g evaluates the number of contacts in the following way; g(window)=n_{days-int eration}/n_{days}, wherein the numerator is the number of days with interactions during the timeframe, and wherein the denominator is the number of days in the timeframe; and,

function h evaluates the ratings using an exponential moving average: h(window):gₜ=α·rₜ₋₁+(1−α)·gₜ₋₁, where t>2, starting from 0 (oldest interaction) to t=latest interaction, rₜ is the rating of the interaction at time t, and α=[0,1].

### BRIEF DESCRIPTION OF THE DRAWINGS

FIG. 1 is schematic representation of a peer-to-peer networking system according to the present disclosure.

### DETAILED DESCRIPTION

One exemplary solution includes a system that implements a social networking arrangement in a peer-to-peer (P2P) distributed manner, in order to provide social networking features to the users of an eco-system or environment of micro-markets. The system can use a Distributed Hash Table (DHT) to manage the objects of the social networking system, e.g., contact lists that represent the social network of the users. The system implements a function to manage over time the social connections among users, strengthening or weakening the social connection dynamically, depending on the interactions among users, frequency, and on passing time. The system can take care of providing availability of the social network in the face of failures, and data integrity.

An eco-system or environment of micro-markets can benefit from a P2P approach to network with each-other and their users, thus enabling data-sharing, data-location, and other interactions to improve the usability and value to the users. Scalability, self-organization, and reduced management overhead are some of the beneficial outcomes.

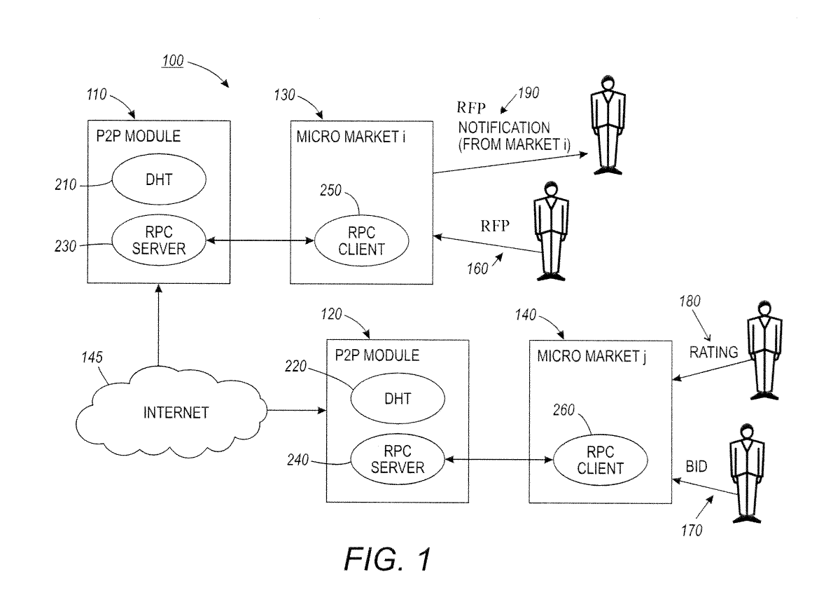

To be described in more detail hereinafter, (referring to FIG. 1) the system 100 provides the following set of features in a P2P manner 110, 120, and also to multiple micro-markets 130, 140 deployed on the Internet or other networked arrangements 145:
a data-center-less social network, built automatically from user interactions in the markets;
proactive replication of Request for Proposals (RFPs) or advertisements 160 to relevant micro-markets 130, 140; and,
automatically suggesting RFPs to a bidder 170, which are located in a different market, but are relevant to the bid.

The system 100 enables social networking between RFP posters or publishers 160 and bidders or recipients 170 in a data-center-less manner. The main criteria to build the social network will be work recently done together or connections, i.e., if RFP poster or publisher i awards a bid to bidder or recipient j, then a connection can be created. This connection can be strengthened or weakened (and eventually forgotten) depending both on (1) the number of working interactions recently done together and (2) the rating 180 of those interactions. Such a social network will enable multiple features, e.g., automatically advertising a new RFP 160 to people or recipients 170 that are likely to be interested and likely to win the RFP.

One of the challenges in implementing this social network stems from the required ease of deployment of a market. Anyone with a regular Internet connection can play a host to create a market. Another challenge results from the distributed nature of the markets and their users, which do not have central coordination, e.g., user k can post an RFP in market j and market i, but those markets can be unrelated and unconnected.

One implementation of the data-center-less social network, leverages a Distributed Hash Table (DHT). The DHT can form a network overlay—or P2P system—using the markets, i.e., each market can be a node in an overlay graph. DHTs can provide a key-value store that scales with the number of participating nodes. The creation and maintenance of a DHT can be done by fully decentralized protocols that are designed to handle node failures and other sources of churn in the system.

The basic functionality of a DHT is to route a key to a node in the overlay. The node responsible for that key will be used to store the value. If we later want to look up the value that belongs to a key, the DHT will again route the key to the relevant node. The number of routing hops in popular overlays—such as Chord, FreePastry and Kademlia—is O(log(N)), where N is the number of nodes in the system. Additionally, the distribution of keys across the nodes can be uniform, due to the behavior of the key routing algorithms. DHTs usually (not always) replicate a key-value pair into one or more nodes, because it can be assumed that any node can fail or leave at any time.

One can use the DHT to store a list of n connections for each user, RFP-poster, and/or bidder. The contacts of a particular user can be RFP-posters or bidders. These contacts are made when a bid is awarded. To do this, the system can assume that each user is identified by a globally-unique key, such as an email or a public-key.

The social network system can take care of replicating the list of connections to avoid data loss. This replication can be done with or without the help of the underlying DHT. Additionally, the system can take care of properly updating the list of connections as time goes by and new user interactions happen.

Whenever a bid is awarded, a new connection can be created. The micro-market will communicate this event to the social network system. The system can then request the contact list, using the DHT, for that particular RFP owner. To request the contact list, the global identification of the RFP owner can be used. If there is no contact list, then a new one can be created. The connection can be represented by the global identification of the bidder, the identification of the RFP in question, a connection strength which can be labeled strong, weak, or undetermined, and a list of interactions (bid awarded, rating assigned) with dates. This last list can be limited in size: for example, interactions beyond a certain date can be forgotten by the system. The size of the ‘window’ can be a system-wide parameter. This list can be the input to the function, explained below, which can then calculate the strength of a connection.

The connection can also be created when a bidder has finished the assigned work. When that happens, a rating of the interaction will be assigned in the micro-market, and this rating will be communicated to the social network system. If a connection to that bidder is not present, then it will be created.

The system can limit the size of a contact list to nᵣ entries. If there is no space to create the new connection, one will have to be dropped. To drop a connection, the system will look for a contact with undetermined connection strength. If there is no such contact, then a weak strength contact with the oldest date of interaction can be dropped. If all contacts happen to be strong, then the social network system can communicate this to the micro-market, and the micro market will let the user decide if a strong connection can be dropped or not to make space for the new connection.

As discussed above, the connections between users can be dynamically created based on past interactions between users. The connections can be further modified based on the ratings of the interactions. For example, if work is done in market A, then a connection gets created between a bidder B and the individual that posted the position (poster P). If the interaction or connection was positive, then that will strengthen the social connection. At a later time, if the bidder B goes to market, because of the existing social network, bidder B can receive information, based on that social connection that was created while interacting with poster P.

The social connections can be created based on direct interactions between two users such that the connections will be created between someone that created, for example, a job and the individual that is going to get that job. Any individual can have any of the two roles, the individual can create and post jobs or an individual can bid and win jobs. Thus, there will be connections to people that have worked with a user, for people that have done work for the user, or people that the user has worked for.

Connections can be updated in two different manners: (1) when a new bid is awarded to a bidder that is already connected to the RFP owner, and (2) when a bidder has finished the assigned work, and the RFP owner creates a rating for the interaction. In both cases, the micro-market updates the social network system with the relevant information: the identification of the RFP owner, the identification of the bidder, the date of the interaction, and the rating of the interaction (if any).

As mentioned above, a connection can contain a list of the latest interactions. Interactions beyond a particular date, for example, six months old, can be forgotten—thus the list is a user determinable moving time window. These interactions are used to compute the strength of a connection. A simple approach would be to count the number of interactions, and if they are above a threshold, then the strength of the connection gets upgraded. Another approach would be to use a function that takes into account the number of interactions, and the ratings assigned to the user, refer to description below.

In the latter approach introduced above, the connection can be expressed as follows:

f(window)=β·g(window)+(1−β)·h(window), where β=[0,1].

Function g evaluates the number of contacts in the following way: g(window)=n_{days-int eraction}/n_{days}, where the numerator is the number of days with interactions during the timeframe, and the denominator is the number of days in the timeframe. Function h evaluates the ratings using an exponential moving average: h(window):gₜ=α·rₜ₋₁+(1−α)·gₜ₋₁, where t>2, starting from 0 (oldest interaction) to t=latest interaction, rₜ is the rating of the interaction at time t, and α=[0,1]. In summary, the function gives a value in [0,1], weighing the number of contacts during the timeframe versus the ratings during that same timeframe. If the resulting function or number is above a threshold f>τ, then the connection can be described as strong, otherwise, it can be described as weak.

When user i posts an RFP 160, i's identification will be used with the underlying DHT 210, 220 to retrieve i's connections. The identification of the s strongest connections can be used with the underlying DHT to store an RFP-notification 190. When any of the users represented by those connections logs into a market, the market will query the DHT 210 using their identification to verify if there is any RFP-notification 190 for them. The notification 190 can include the name of the RFP 160, and the market 130, 140 where the RFP is posted. Note that more than one notification can be available. To prevent too many notifications from accumulating, the system can drop notifications that are too old (i.e. greater than six (6) weeks old), and will only allow a predeterminable limited number nₙ of notifications to be stored.

A micro-market can try to exploit the previous mechanism by sending multiple notifications to random bidders. This flooding cannot be prevented, but it can be made ineffective. When a notification arrives, the system will query the contact list of the owner of the RFP to determine if the bidder receiving the notification is indeed a strong contact. If the bidder is not a strong contact, then the notification is ignored.

As discussed above, markets can be used as the infrastructure for the social networking P2P system. Because a market can go offline indefinitely, a mechanism is needed to ensure availability of the contact lists that were stored in that market. For fault tolerance, a connection list can be replicated k times in the system. If the DHT handles the replication, then its system will be leveraged. If the DHT lacks replication, then the list can be replicated in the following way: create k new global identifications, where each one is the concatenation of the user's identification and an integer in [0, k−1], and then store the replicas using those identifications.

The aforementioned replication creates issues regarding database management; namely, how to handle replica updates, and how to handle concurrent modifications to a client list.

To update replicas one can use the Paxos consensus algorithm. This algorithm can be used to ensure that all replicas are properly updated, even if a host fails during an update. The Paxos algorithm requires a distinguished replica to initiate the consensus algorithm. In the exemplary system, the distinguished replica will be the main contact list, i.e., the contact list located by routing the identification of the user through the DHT. Thus, all update operations will arrive to that particular node and not to the nodes storing the replicas.

Issues regarding concurrent modifications should not be a major issue, due to the fact that users will typically not be awarding bids concurrently from multiple markets, nor will users rate interactions concurrently from multiple markets.

Contact lists can be signed using asymmetric key cryptography. Cryptography can be used to protect the integrity of the list in the face of possible unwarranted modifications by the node storing the list in the DHT. The signature itself will be an object in the DHT, and its identification will be the identification of the user concatenated to the word signature. Whenever a contact list is modified due to an interaction between the owner of the list and another user, the signature will be recomputed and stored. This assumes that the micro-market interface will let the user compute the signature in its web browser.

To compute the signature, the data in the contact list can be first serialized into a string sequence encoded in base 64. Therefore, anyone reading a particular contact list can verify that it has not been corrupted; just by having access to the public key of the user that owns that contact list (the public key itself could be stored in the DHT for convenience).

FIG. 1 displays an exemplary software stack and implementation. The social network system 100 can be implemented independently from the micro-markets 130, 140. The network system 100 can contain DHT's 210, 220, and Remote Procedure Call (RPC) servers 230, 240. For the DHT's 210, 220, one exemplary system includes FreePastry, but different DHT's could be used in place of FreePastry. Apache Thrift can be used as the RPC server 230, 240. The RPC servers 230, 240 can be used exclusively to allow the micro-markets 130, 140 to talk to the social network 100. Using the RPC clients 250, 260, the micro-markets 130, 140 can send queries or events (such as awarded bid) to the social network system 100. The coding necessary to extend the micro-markets 130, 140 with the RPC clients 250, 260 can be done in any of a number of multiple languages (i.e. Ruby, C++, Java, etc.).

The distributed hash table enables a distributed database that can be distributed across all the participating micro markets. The DHT enables work to be done based on a key and it receives a value that is a value that is going to be attached to that particular key. The distributed hash table, for example, stores the list of connections of an individual user and the key would be a user identification. Additionally, the distributed hash table can manage all the data related to the objectives of the social network, like setting up the tags through the social connections.

In the present disclosure, a proposed novel architecture of server-less social network using peer-to-peer techniques such as DHT has been described. The application of the DHT technique in a context of server-less social network for micro-markets has not heretofore been described. Also, the enhancement of existing micro-market features such as, for example, job advertisement by connection is novel.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A system, comprising:
a plurality of devices implementing a plurality of peer nodes coupled to a data-center-less network, wherein each of the plurality of devices implements at least one peer node;
at least one of the plurality of peer nodes is configured as a publisher peer node for a plurality of contents cached on the respective peer node, wherein each publisher peer node is configured to publish one or more advertisements on the network;
the data-center-less network is built automatically from user interactions in the markets and includes proactive replication of advertisements to relevant micro-markets;
automatic suggesting of the advertisements to a bidder, which are located in a different market, but are relevant to the bid; and,
wherein the automatic suggesting is based upon a computed strength of a connection between the publisher and the bidder using prior interactions.

2. The system as recited in claim 1, wherein the computed strength of the connection is modified depending on both: the number of working interactions recently done together; and, the rating of those interactions between the publisher and the bidder.

3. The system as recited in claim 2, wherein the connection is based upon the following:
f(window)=β·g(window)+(1−β)·h(window), where β=[0,1];
function g evaluates the number of contacts in the following way: g(window)=n_{days-int eraction}/n_{days}, wherein the numerator is the number of days with interactions during the timeframe, and wherein the denominator is the number of days in the timeframe; and,
function h evaluates the ratings using an exponential moving average: h(window):gₜ=α·rₜ₋₁+(1−α)·gₜ₋₁, where t>2, starting from 0 (oldest interaction) to t=latest interaction, rₜ is the rating of the interaction at time t, and α=[0,1].

4. The system as recited in claim 3, wherein the function f gives a value in [0,1], weighing the number of contacts during the timeframe versus the ratings during that same timeframe; and,
wherein if the resulting function f is above a threshold f>τ, then the connection can be described as strong, otherwise, the connection can be described as weak.

5. A system, comprising:
a plurality of devices implementing a plurality of peer nodes coupled to a data-center-less network;
at least one of the plurality of peer nodes is configured as a publisher peer node for a plurality of contents cached on the respective peer node, wherein each publisher peer node is configured to publish one or more advertisements on the network;
the data-center-less network is built automatically from user interactions in the markets and includes proactive replication of advertisements to relevant micro-markets;
automatic suggesting of the advertisements to a bidder, which are located in a different market, but are relevant to the bid;
wherein the automatic suggesting is based upon a computed strength of a connection between the publisher and the bidder; and,
wherein the computed strength of the connection is modified depending on the number of working interactions recently done together between the publisher and the bidder.

6. The system as recited in claim 5, wherein the computed strength of the connection is further modified depending on a rating of the working interactions.

7. The system as recited in claim 6, wherein the connection is based upon the following:
f(window)=β·g(window)+(1−β)·h(window), where β=[0,1];
function g evaluates the number of contacts in the following way: g(window)=n_{days-int eraction}/n_{days}, wherein the numerator is the number of days with interactions during the timeframe, and wherein the denominator is the number of days in the timeframe; and,
function h evaluates the ratings using an exponential moving average: h(window):gₜ=α·rₜ₋₁+(1−α)·gₜ₋₁, where t>2, starting from 0 (oldest interaction) to t=latest interaction, rₜ is the rating of the interaction at time t, and α=[0,1].

8. The system as recited in claim 7, wherein the function f gives a value in [0,1], weighing the number of contacts during the timeframe versus the ratings during that same timeframe; and,
wherein if the resulting function f is above a threshold f>τ, then the connection can be described as strong, otherwise, the connection can be described as weak.

9. A system, comprising:
a plurality of devices implementing a plurality of peer nodes coupled to a data-center-less network, wherein each of the plurality of devices implements at least one peer node;
at least one of the plurality of peer nodes is configured as a publisher peer node for a plurality of contents cached on the respective peer node, wherein each publisher peer node is configured to publish one or more advertisements on the network;
the data-center-less network is built automatically from user interactions in the markets and includes proactive replication of advertisements to relevant micro-markets; and,
a computed strength of a connection between a publisher and a bidder using prior interactions wherein the connection is based upon the following:
f(window)=β·g(window)+(1−β)·h(window), where β=[0,1];
function g evaluates the number of contacts in the following way: g(window)=n_{days-int eraction}/n_{days}, wherein the numerator is the number of days with interactions during the timeframe, and wherein the denominator is the number of days in the timeframe; and,
function h evaluates the ratings using an exponential moving average: h(window):gₜ=α·rₜ₋₁+(1−α)·gₜ₋₁, where t>2, starting from 0 (oldest interaction) to t=latest interaction, rₜ is the rating of the interaction at time t, and α=[0,1].

10. The system as recited in claim 9, further comprising:
automatic suggesting of the advertisements to the bidder, which are located in a different market, but are relevant to the bid; and,
wherein the automatic suggesting is based upon the computed strength of the connection between the publisher and the bidder using prior interactions.

11. The system as recited in claim 10, wherein the computed strength of the connection is modified depending on the number of working interactions recently done together between the publisher and the bidder.

12. The system as recited in claim 11, wherein the computed strength of the connection is further modified depending on a rating of the working interactions.

13. The system as recited in claim 9, wherein the function f gives a value in [0,1], weighing the number of contacts during the timeframe versus the ratings during that same timeframe; and,
wherein if the resulting function f is above a threshold f>τ, then the connection can be described as strong, otherwise, the connection can be described as weak.
